(19) United States
(12) Patent Application Publication
(10) Pub. No.: US 2009/0236851 A1
(43) Pub. Date: Sep. 24, 2009

(54) COUPLING ARRANGEMENT

(76) Inventors: Ian Hampel, New South Wales (AU); Kostantin Velev, Victoria (AU)

Correspondence Address: Thomas E Sisson;Jackson Walker, 112 E Pecan St, Suite 2400, San Antonio, TX, 78205, US

(21) Appl. No.: 12/310,256

(22) PCT Filed: Aug. 17, 2007
(86) PCT No.: PCT/AU2007/001166

§ 371 Date: Feb. 18, 2009

(30) Foreign Application Priority Data
Aug. 18, 2006 (AU) 2006904512

(51) Int. Cl. F16L 37/24

(52) U.S. Cl. 285/403

(57) ABSTRACT

A coupling arrangement (10) including a first coupling (12′) and a second coupling (16), the first and second couplings being connectable to form a joint (12). Each of the first and second couplings defines a passage through which fluid can flow and the respective passages are in alignment when the first and second couplings (12′, 16′) are connected. Each of the first and second couplings (12′, 16′) includes first and second interconnecting coupling parts (20, 60) in which the first coupling part defines the passage. The second coupling part (60) is connectable to the first coupling part (20) and to a first coupling part of another coupling to form the joint. The first and second couplings (12′, 16′) are coupled together by a releasable connection between the second coupling part (60) of each coupling with the first coupling part (20) of the mating coupling.

The present invention relates to a coupling arrangement for use with flexible fluid lines, such as garden hoses. It will be convenient to describe the invention in relation to its use with garden hoses, although it should be appreciated that the invention can be employed in flexible fluid lines used for other purposes.

A popular form of connection between a hose and hose fittings employs click or snap connectors. While such connectors are easy to use, they typically are of relatively complex construction including several moving parts, so that they are relatively expensive to manufacture and are susceptible to damage or failure upon ingress of foreign matter such as soil.

International application WO91/00469 discloses a fluid line coupling developed by one of the inventors of the present application. That coupling includes two interconnecting parts, one of which is connectable to a fluid line and the other to either of a fluid supply or discharge facility. Drawbacks associated with this type of coupling is that the interconnecting parts are quite separate and include no common parts while it provides no interface with the popular form of snap-fit discharge nozzle which is so popular throughout the world. Thus, the coupling was usually only able to be coupled to a fluid discharge facility, i.e. a tap.

International application WO 98/41791 discloses a hose coupling having similar drawbacks to WO 91/00469 discussed above. Thus, the hose coupling of this reference requires a different connection to each of a fluid supply or discharge facility or a hose while, additionally, the sealing arrangement between the connectable coupling parts of the hose coupling is prone to leakage.

It is an object of the present invention to provide a coupling arrangement preferably for a flexible fluid line which is an improved coupling compared to prior art couplings.

In a broad form of the invention there is provided a coupling arrangement including a first coupling and a second coupling, the first and the second couplings being connectable together to form a joint, each of the first and second couplings defines a passage through which fluid can flow, and in a connected condition of the first and second couplings, the respective passages are in alignment to allow flow of fluid through the joint, each of the first and second couplings includes first and second interconnecting coupling parts, in which the first coupling part defines the passage of the coupling, the second coupling part of each coupling is connectable to the first coupling part of the coupling with which it is associated, and to the first coupling part of the other coupling of the joint, the first and second couplings are coupled together by releasable connection between the second coupling part of each coupling with the first coupling part of the mating coupling.

In a more specific form of the invention there is provided a coupling arrangement for coupling a flexible fluid line between a fluid supply facility or a fluid discharge facility, the coupling arrangement includes a first coupling which is connectable to the fluid supply facility or to the fluid discharge facility, and a second coupling which is connectable to an opposite end of the flexible fluid line, the first and the second couplings are connectable together to form a joint, each of the first and second couplings defines a passage through which fluid can flow, and in a connected condition of the first and second couplings, the respective passages are in alignment to allow flow of fluid through the joint, each of the first and second couplings includes first and second interconnecting coupling parts, in which the first coupling part defines the passage of the coupling, the first coupling part of the first coupling is connectable to one of the fluid supply or fluid discharge facilities, the second coupling part of each coupling is connectable to the first coupling part of the coupling with which it is associated, and to the first coupling part of the other coupling of the joint, the first and second couplings are coupled together by releasable connection between the second coupling part of each coupling with the first coupling part of the mating coupling.

In a still more specific form of the invention there is provided a coupling arrangement for coupling a flexible fluid line between a fluid supply facility and a fluid discharge facility. In above forms of the invention, the fluid supply facility can be a domestic garden tap for example, while the fluid discharge facility can be a spray nozzle or water sprinkler. The coupling arrangement includes a flexible fluid line between a fluid supply facility and a fluid discharge facility, the coupling arrangement includes a first coupling which is connectable to the fluid supply facility and to the fluid discharge facility, and a second coupling which is connectable to opposite ends of the flexible fluid line, the first and the second couplings are connectable together to form a joint, each of the first and second couplings defines a passage through which fluid can flow, and in a connected condition of the first and second couplings, the respective passages are in alignment to allow flow of fluid through the joint, each of the first and second couplings includes first and second interconnecting coupling parts, in which the first coupling part defines the passage of the coupling, the first coupling part of the first coupling is connectable to one of the fluid supply or fluid discharge facilities, the second coupling part of each coupling is connectable to the first coupling part of the coupling with which it is associated, and to the first coupling part of the other coupling of the joint, the first and second couplings are coupled together by releasable connection between the second coupling part of each coupling with the first coupling part of the mating coupling.

By the above arrangement, the second coupling parts of the first and second couplings of each joint can be of the same construction, or in other words, the second coupling parts can be a universal part regardless of whether it is associated with the first or second coupling. This is advantageous in relation to minimising the complexity of the couplings and the cost of manufacture, and reducing the overall number of parts required for couplings that connect to a fluid supply facility and to a fluid discharge facility. In this latter respect, it will become apparent from the discussion which follows that a significant advantage is provided by the invention compared to prior art couplings. For example, in a common domestic system, in which a hose is attached to a tap at one end and to a spray nozzle at the other end, a coupling arrangement of the invention can be applied so that the first coupling of each joint attaches respectively to the tap and the nozzle, and the second coupling attaches to each end of the hose. Thus, the first coupling of each joint is identical. Adaptors can be employed if necessary to assist connection between the first couplings and the tap and nozzle. Moreover, the second coupling of each joint is also identical if the hose diameters are identical, or if they are different, the first coupling parts of the second couplings are different, but the second coupling parts remain identical.

Where a system of the kind discussed above also employs a connection between two or more hoses, that connection can comprise a pair of second coupling attached together. Thus, in that system, the first couplings connect to the tap and nozzle, and the second couplings attach to each hose end. The system thus comprises only the first and second couplings, with adaptors employed as required.

Other aspects of the present invention are embodied in a seal provided for use in a coupling arrangement, in adaptors to facilitate connection of a coupling according to the invention to fluid supply or discharge facilities, particularly existing facilities that are not customised for use with a coupling according to the invention, and in a hose grip which is employed to grip the outside surface of one end of a hose to which a coupling is connected.

In one form of the invention, an adaptor is employed with the first coupling for connection of the first coupling to a fluid discharge facility. The use of an adaptor facilitates connection of the first coupling to fluid discharge facilities of various kinds and in particular, to such facilities that include connection arrangements for couplings having a different construction to the first coupling of the present invention, such as prior art couplings. As discussed earlier, a very popular form of connection arrangement particularly used for water nozzles, is a connector which includes a male tubular connector that extends from the nozzle. The male connector includes a coaxial flange and O-ring, which accepts a “click-on” female fitting which is attached to one end of a hose. While this arrangement is popular, for example for connecting water spray nozzles to hoses, the click-on nature of the arrangement introduces significant complexities into the parts of the connection arrangement, which increases both the cost of the arrangement and the likelihood of its failure. Nevertheless, the popularity of the arrangement is such that many households and businesses already have nozzles and other fittings of this kind and therefore it is anticipated that there would be a reluctance to dispose of these fittings in order to adopt the present invention. Accordingly, the adaptor of the invention advantageously permits continued use of existing fittings while adopting the coupling arrangement of the present invention.

An adaptor according to one form of the invention includes first and second portions. The first portion is arranged to be secured to the male connector of the fluid discharge facility, while the second portion is arranged to be connected to the first coupling part of the first coupling. The first portion includes an opening through which the male connector can be fed and an edge of the opening is arranged to bear against a bearing surface of a flange of the male connector. That bearing engagement resists removal of the male connector from the opening and thus it resists removal of the adaptor from the male connector. The arrangement is such that with the edge of the opening in bearing engagement with the bearing surface of the flange, and the first coupling part secured to the second portion of the adaptor, the first coupling is secured to the fluid discharge facility.

In a preferred arrangement, the opening includes two intersecting portions. A first portion is sized to accept the male connector when the connector is fed into the opening, while the second portion is sized and shaped for engagement with the bearing surface of the connector flange. For a male connector that is cylindrical, each portion can be circular, with the first portion having a diameter that is slightly greater than the maximum diameter of the portion of the male connector that is fed through the opening, and the second portion can be of a reduced diameter and complementary to the diameter of the section of the male connector from which the flange extends. In this arrangement, the circular edge of the second portion can bear radially against the outer surface of the male connector and axially against the bearing surface of the flange. In this arrangement, the axis of the second portion preferably is coaxial with the male connector, while the axis of the first portion is eccentric to the axis of the male connector. Thus the adaptor is shifted eccentrically from the position in which the male connector is fed into the opening, to the position in which the opening bears radially against the outer surface of the connector and axially against the flange.

The second portion of the adaptor can be arranged for connection to the first coupling part in any suitable manner. A bayonet or snap connection could be employed, although it is preferred that the connection be a threaded connection.

In the above form of adaptor, it is preferred that the adaptor be applied to the male connector first and that the first coupling part thereafter be connected to the adaptor.

An alternative form of adaptor also includes first and second portions of which the first portion is arranged to be secured to the male connector of the fluid discharge facility and the second portion is arranged to be connected to the first coupling part of the first coupling. In this alternative form of adaptor, the first portion includes a snap connector, which rides over the flange of the male connector and into bearing engagement with the bearing surface of the flange. The snap connector can include a pair of separate connector parts which engage different sections of the bearing surface, preferably sections which are diametrically opposed. The connector parts either are resiliently flexible or are supported by resiliently flexible elements, so that the parts can resiliently shift to ride over the flange and can then return to bear against the bearing surface.

In one arrangement, the second portion includes an annular wall and the snap connector or connector parts are connected to an internal surface of that wall. In this arrangement, a thread can be applied to the outer surface of the wall for threadably connecting the second portion to the first coupling part.

In the above alternative form of the adaptor, the snap connector or connectors can include levers for manually releasing the connectors from bearing engagement with the bearing surface, so as to release the adaptor from connection with the fluid discharge facility. Manual release may be by way of finger manipulation of the levers, or a tool, such as a screwdriver may be employed. The levers may be integrally formed with the snap connectors and in one form, the levers extend axially from the snap connectors to a position beyond one axial end of the annular wall of the second portion in the trailing direction of application of the adaptor to the male connector of the fluid discharge facility. In this arrangement, when the first coupling part is connected to the second portion of the adaptor, the first coupling part can enclose the levers against access for manual release.

An advantage of the alternative form of adaptor is that the adaptor can be fitted to the first coupling part first and thereafter, the combined adaptor and first coupling part can be fitted to the fluid discharge facility. In contrast, in the first form of the adaptor, the adaptor is fitted to the fluid discharge facility first and then the adaptor and the first coupling part are connected together.

The first coupling part preferably includes a connecting section which is connectable to the fluid supply or discharge facility. The connecting section can be arranged for that connection in any suitable manner, although the preferred arrangement includes an annular wall having an internal surface to which a helical thread is applied. The helical thread can be of a form to connect standard threads which are applied to fluid supply facilities such as taps.

The passage of the first coupling part can extend from an inboard end of the connection section. This is suitable for coupling parts which are configured for connection to a tap or discharge facility. Thus, the connecting section has an axial extent and the passage commences inboard of an axial end of that section. A seal can be accommodated between one end of the fluid supply facility and the first coupling part, to seal against flow of fluid other than into the passage. For this, a seat can be provided for a seal and in the preferred arrangement, the seat is annular and extends about the opening of the passage, between the passage opening and the connecting section.

A first coupling part which is arranged for connection to a flexible fluid line can include a hollow spigot for receipt within an end of the line. The spigot will be in fluid communication with the passage and preferably is coaxial therewith, for example an extension thereof. The spigot preferably tapers slightly to be narrower at its leading end than its trailing end, so that the end of the fluid line into which the spigot is inserted, leading end first, frictionally engages the external surface of the spigot progressively more the further the spigot is inserted. The spigot can be formed integrally with the first coupling part.

The passage extends through an interlocking portion of the first coupling part to which the second coupling part can be connected to form a coupling, and to which a second coupling part of another coupling can also be connected. Thus, the interlocking portion is arranged to interlock with the second coupling parts of each of the first and second couplings. The interlocking portion preferably is generally cylindrical and includes projections for interlocking with the respective second coupling parts. The interlocking portion can be in the form of a post or hollow spigot.

The interlocking portion can extend from the connecting section of the first coupling part and in a preferred arrangement, a shoulder is defined at the junction of the connecting section and the interlocking portion which extends transverse to and preferably substantially perpendicular to the axis of the passage and which forms an abutment surface for abutment with the second coupling part when the first and second coupling parts are connected together. The interlocking portion can include one or more locking projections spaced from the shoulder and the second coupling part can also include locking lugs that are received between the shoulder and one or more locking projections when the first and second coupling parts are connected together. The locking lugs of the second coupling part are configured to be received between the shoulder and the locking projections and the locking lugs can include abutments to abut one or either side of the locking projections to securely capture them in the appropriate position. The first and second coupling parts can be connected together by rotation, to bring the locking lugs to the position between the abutments and between the shoulder and the locking projections. One of the abutments may be formed at one end of a ramp, so that a locking lug rides over the ramp to be received between the abutments. In this arrangement, either the locking lug or the ramp, or both, are resiliently flexible to facilitate the lug riding over the ramp. Because of the resilient flexing of the locking lug and/or the ramp, this arrangement can be such that the first and second coupling parts are permanently coupled together by permitting flexing to occur in only one direction of rotation.

The second coupling part of each coupling includes at least one, but preferably two locking claws, for interlocking with the first coupling part of another coupling. The claws have an axially extending claw section and a radially inwardly extending claw section. The radially extending claw section preferably extends from a distal end of the axially extending section. The second coupling part can include an annular wall from which the locking claws extend and the locking lugs previously described can extend radially inwardly from the wall. The locking lugs and the radially extending claw sections are spaced apart axially.

The radially extending claw sections are arranged for locking engagement with further projections extending from the interlocking section of the first coupling part of a coupling. Pairs of projections which are spaced apart axially, can be provided for engagement with a locking lug of one second coupling part and with a radially extending claw section of another second coupling part.

The locking engagement between the locking claws and the first coupling part preferably comprises bringing a locking face of each of the radially extending claw section and a projection into engagement, preferably by rotation of the first coupling relative to the second coupling. It should be appreciated that the first and second couplings normally would themselves be fully assembled before being joined together and would be connected respectively to either the fluid supply or discharge facility, or to a hose end. The respective locking faces preferably have an interlocking profile so that the faces nest together in the interlocked position. One face could have a recess for example and the other face could have a protrusion, so that upon receipt of the protrusion within the recess, the radially extending claw section and the projection are locked together. Receipt of the protrusion within the recess preferably causes the first and second couplings to click together, so that a person who is assembling the joint receives a tactile indication that proper interlocking has occurred. The first and second couplings may also include mutually abutting surfaces in the interlocked position, to prevent rotation beyond that position. While the abutting surfaces may be provided in any suitable form, where the second coupling parts include locking claws, the axially extending sections of two locking claws of two separate second coupling parts may abut, preferably through side edges thereof.

The seals mounted at one end of a respective passage of the first and second couplings preferably engage sealingly when the first and second coupling are interlocked to form a joint. Preferably the pressure force between the seals increases as the pressure of fluid flowing through the joint increases. This can be achieved by a seal of the kind disclosed in International patent application PCT/AU90/00271, published under WO 91/00469. According to the present invention, a seal of that kind is modified to include a pair of coaxial annular flanges, preferably which extend generally in the direction of fluid flow through the passage.

The first flange is received in an annular recess formed in the wall of the passage. The second flange is radially outboard of the first flange and interlocks with an annular end section of the portion of the first coupling part which defines the passage. The interlock can be achieved in any suitable manner. In one form, the annular end section has a reduced diameter section that forms a neck and the neck is engaged by the second flange. To ensure a secure connection, the arrangement can be such as to require the seal to resiliently flex over the end section, whereafter resilient recovery of the seal results in engagement with the neck.

A seal according to the present invention includes a flexible annular lip that is engaged by fluid flowing through the passage, which causes the lip to splay outwardly. Movement of this kind occurs in the lip of each of the two facing seals and results in the lips dynamically engaging each other during fluid flow. This results in the pressure between the lips increasing as fluid pressure increases. The annular flanges of the seal extend from positions radially outwardly of the annular lip.

The present invention can include a hose grip for gripping the end of a flexible fluid line (hereinafter a hose) to which a second coupling of a joint is to be connected. The hose grip is annular to fit about the hose end and is radially expandable and contractible resiliently along its full axial length. The hose grip of the invention includes a plurality of hinged segments. Each segment is elongate and one end of each segment is hingedly connected to an adjacent end of an adjacent segment on one side thereof, while the opposite end is hingedly connected to the adjacent end of the segment on the opposite side thereof. The hose grip thus can expand and contract either uniformly from one end to the other, or the expansion or contraction can be tapered from one end to the other.

Preferably the hose grip is integrally formed and the segments extend generally parallel and in the general direction of fluid flow through the hose end.

The arrangement of the hose grip is that it is placed about one end of a hose and thereafter, a clamping nut is slid over the hose grip and is engaged with the connecting section of the first coupling part of the second coupling. The nut frictionally engages the hose grip and applies a load which tends to cause the hose grip to radially contract. By that connection, the hose grip is forced into gripping connection with the hose end to forcibly clamp the hose end about the spigot which extends from the connecting section of the first coupling part of the second coupling as previously described. The connecting section and the nut can be connected in any suitable manner, but preferably the connection is a threaded connection. Preferably as threaded engagement progresses between the nut and the connecting section, the radial force applied to the hose grip increases. For this, the nut can include a tapered internal wall which engages the radially external surface of the trailing end of the hose grip to progressively increase the radial force applied to the hose grip.

In a preferred arrangement, the first coupling part of the second coupling can include an annular ring that is concentric with and extends about the spigot of that part, for engagement with the leading end of the hose grip. The annular ring and the leading end of the hose grip can cooperate when assembled together to cause the leading end to radially contract so as to grip the hose end. The annular ring and the hose grip therefore can include faces which slidingly engage, with the faces being inclined, to cause radial contraction of the hose grip as sliding engagement between the faces progresses. The arrangement can be such that the clamping nut can cause radial contraction of one end of the hose grip while cooperation between the hose grip and the annular ring can cause radial contraction of the other end. By this arrangement each end of the hose grip can be radially contracted against the hose end to firmly grip the hose end, by the cooperation at one end of the hose grip with the nut, and at the other end by the annular ring. The annular ring can be integrally formed with the first coupling part.

In order to enhance the gripping qualities of the hose grip, the elements of the hose grip can include teeth which bite into the surface of the hose end. Preferably teeth are formed at the hinge connection between adjacent elements of one end of the hose grip. When a hose is fed through the hose grip, the hose preferably is fed first through the end of the hose grip remote at which the teeth are disposed.

For a better understanding of the invention and to show how it may be performed, embodiments thereof will now be described, by way of non-limiting example only, with reference to the accompanying drawings.

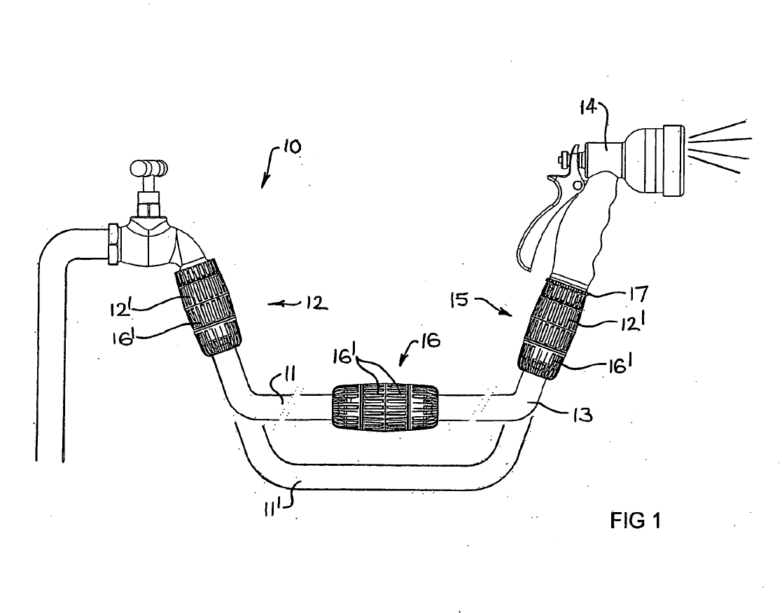

FIG. 1 illustrates a general view of a garden hose arrangement embodying the present invention.

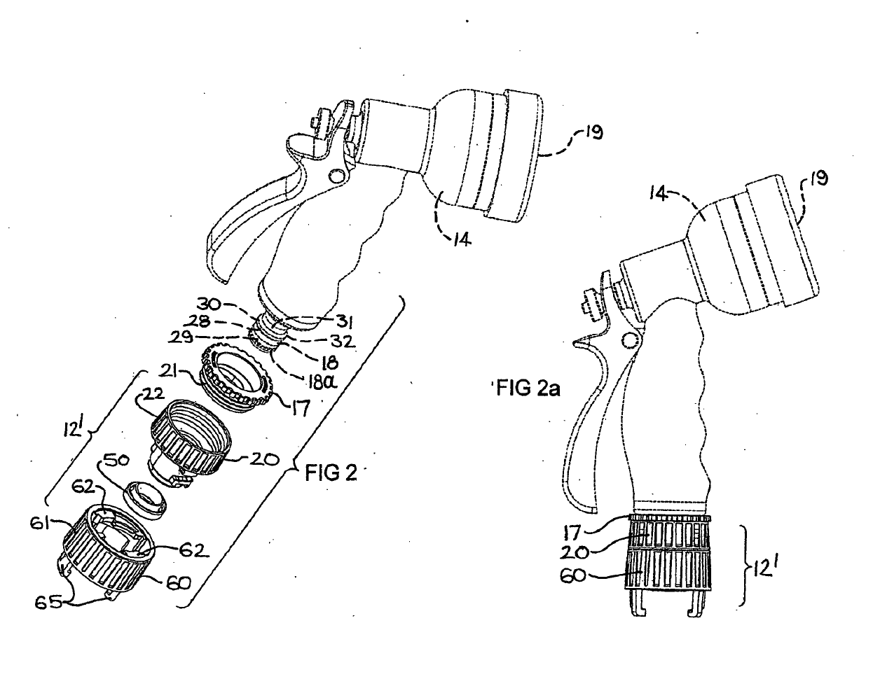

FIG. 2 illustrates a water nozzle and in exploded view a coupling for application to the nozzle.

FIG. 2a illustrates an assembled form of the arrangement of FIG. 2.

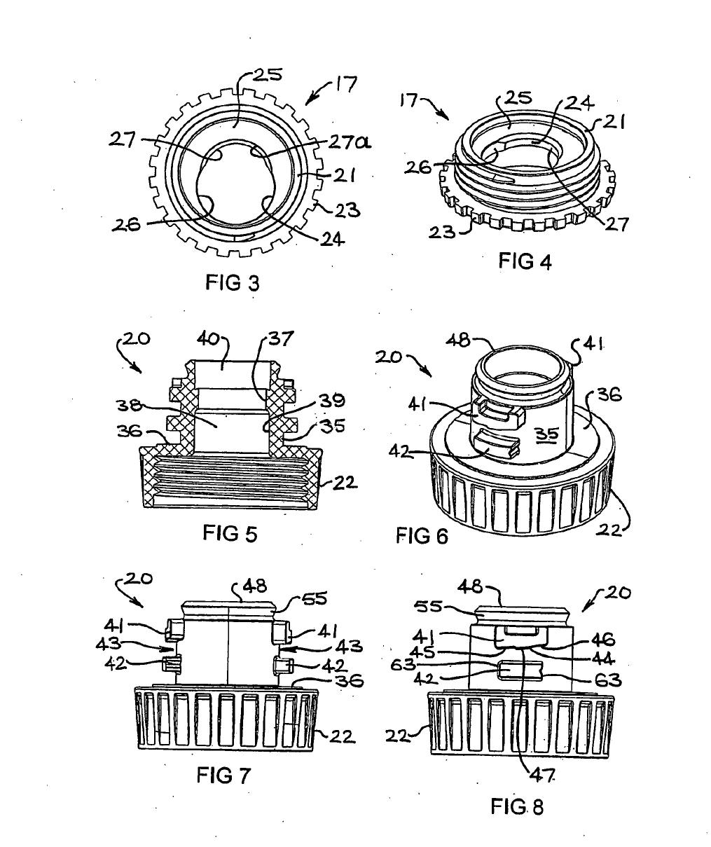

FIGS. 3 and 4 illustrate plan and perspective views of an adaptor according to the invention.

FIGS. 5 to 8 illustrate respectively, cross sectional, perspective and side views of a first coupling part according to the invention.

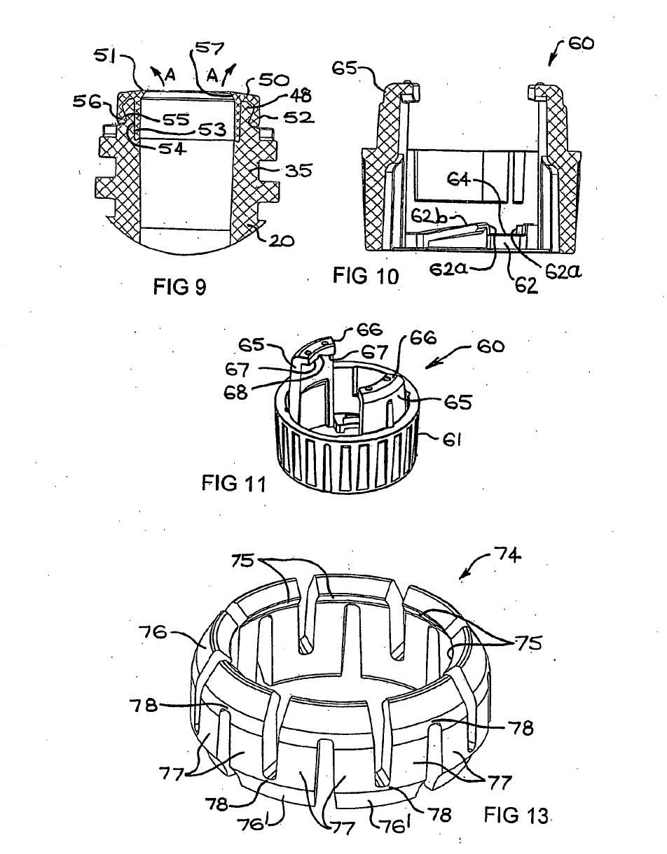

FIG. 9 is a cross-sectional view of a seal according to the invention applied to one end of a first coupling part according to the invention.

FIGS. 10 and 11 are cross-sectional and perspective views of a second coupling part according to the invention.

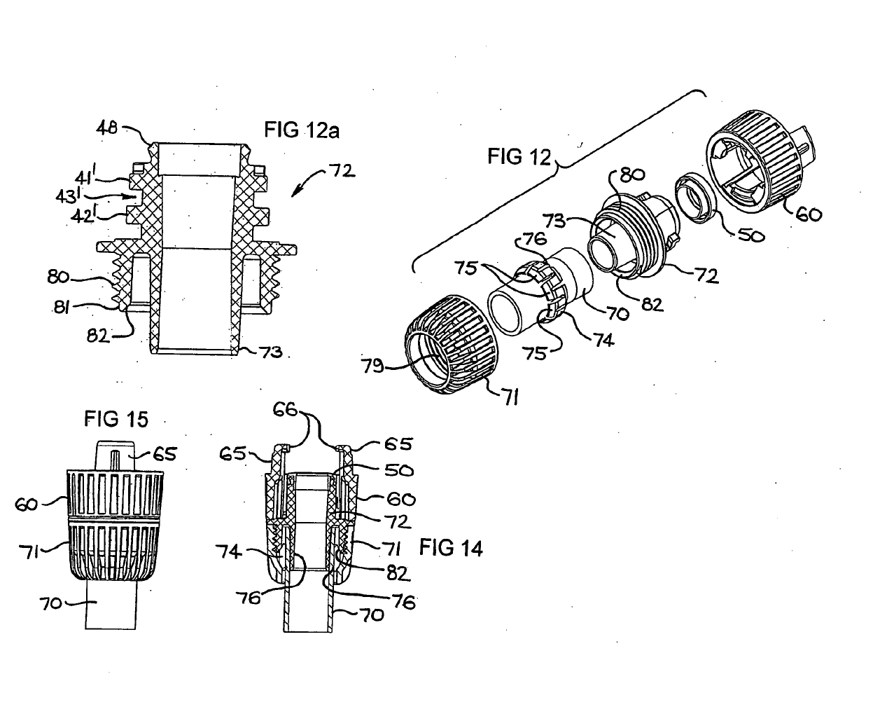

FIG. 12 is an exploded view of a coupling according to the invention for attachment to a hose end.

FIG. 12a is a cross-sectional view of a first coupling part of the coupling shown in FIG. 12.

FIG. 13 is a perspective view of a hose grip according to the invention.

FIGS. 14 and 15 are cross-sectional and side views of the assembled form of the exploded assembly shown in FIG. 12.

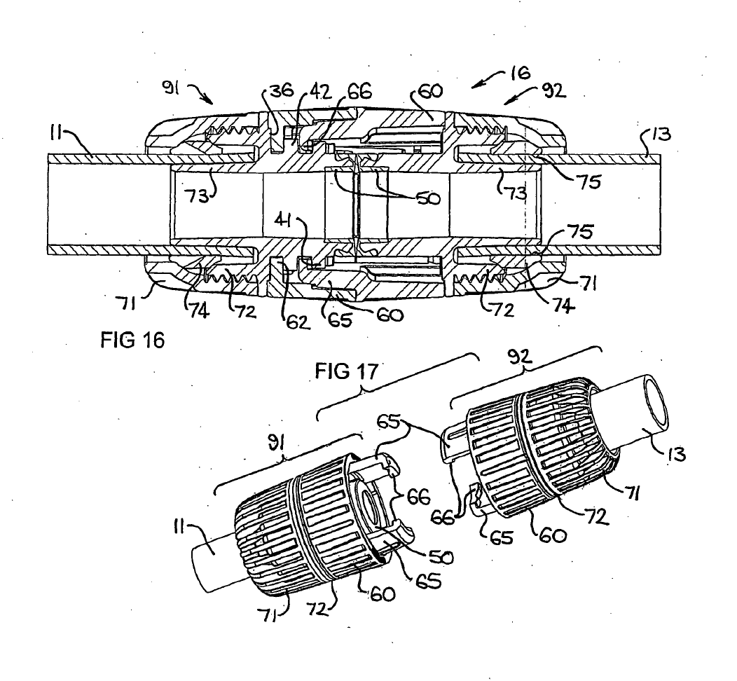

FIG. 16 is a cross-sectional view of a pair of hose ends having the same diameters and which are connected by a coupling arrangement according to the invention.

FIG. 17 is a perspective view of the coupling arrangement of FIG. 16 but shown in a pre-connected condition.

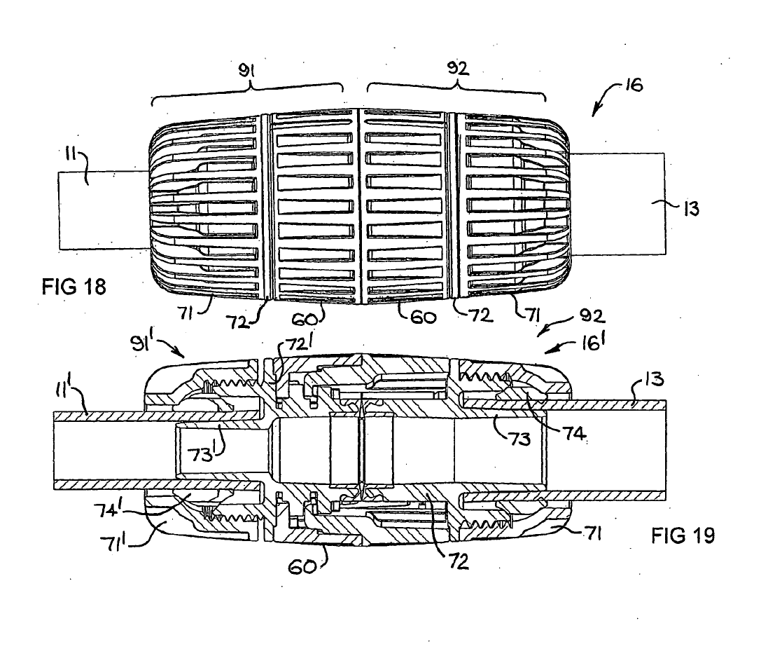

FIG. 18 is a side view of the arrangement of FIG. 17 shown in a connected condition.

FIG. 19 is a cross-sectional view of a pair of hose ends having different diameters and which are connected by a coupling arrangement according to the invention.

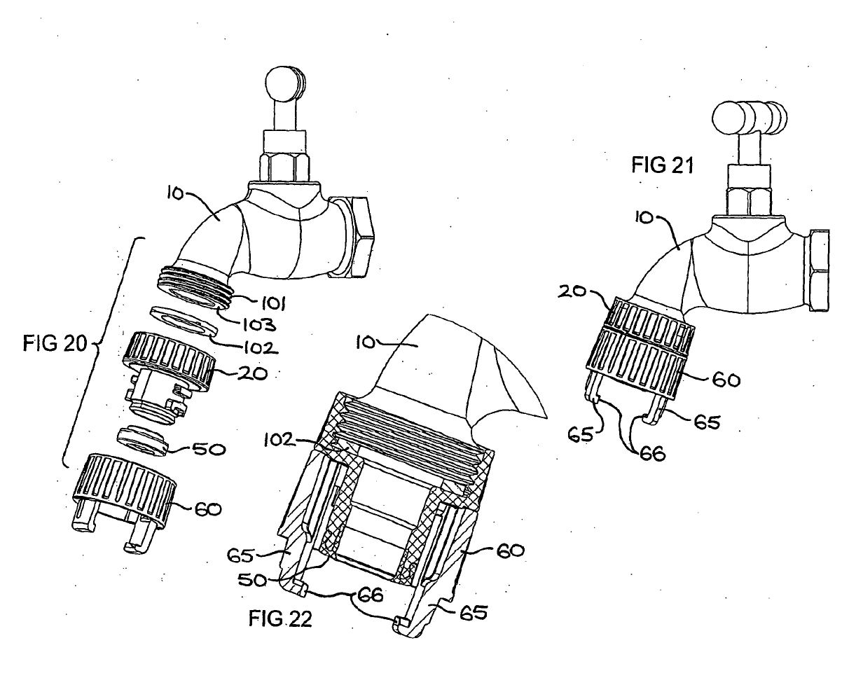

FIG. 20 shows an assembly according to the present invention in exploded view, for attachment to a water tap.

FIGS. 21 and 22 show side and cross-sectional views of the exploded assembly of FIG. 20 in an assembled form.

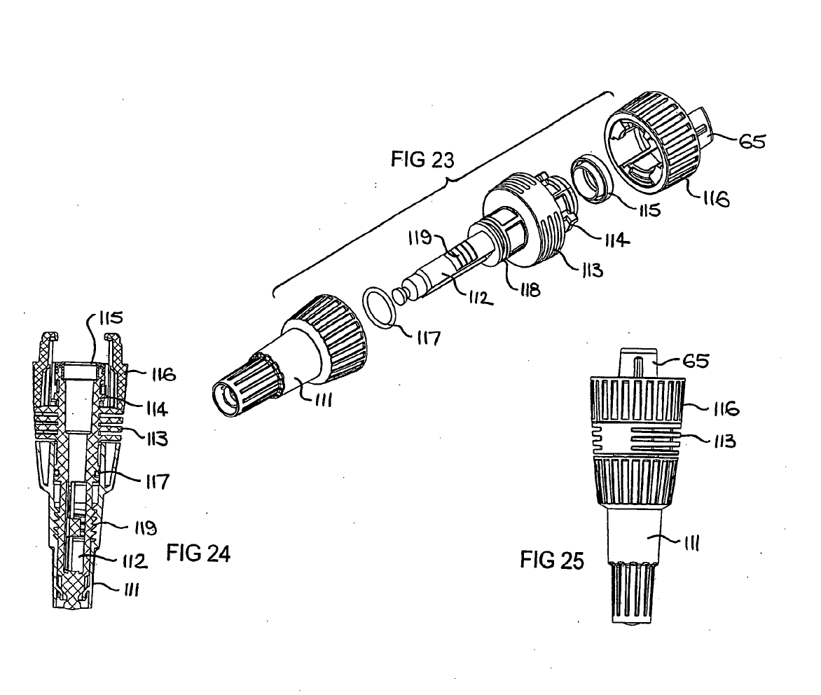

FIG. 23 shows a nozzle shown in exploded view, which is customised for use in a coupling arrangement according to the present invention.

FIGS. 24 and 25 are cross-sectional and side views of the nozzle of FIG. 23 shown in an assembled form.

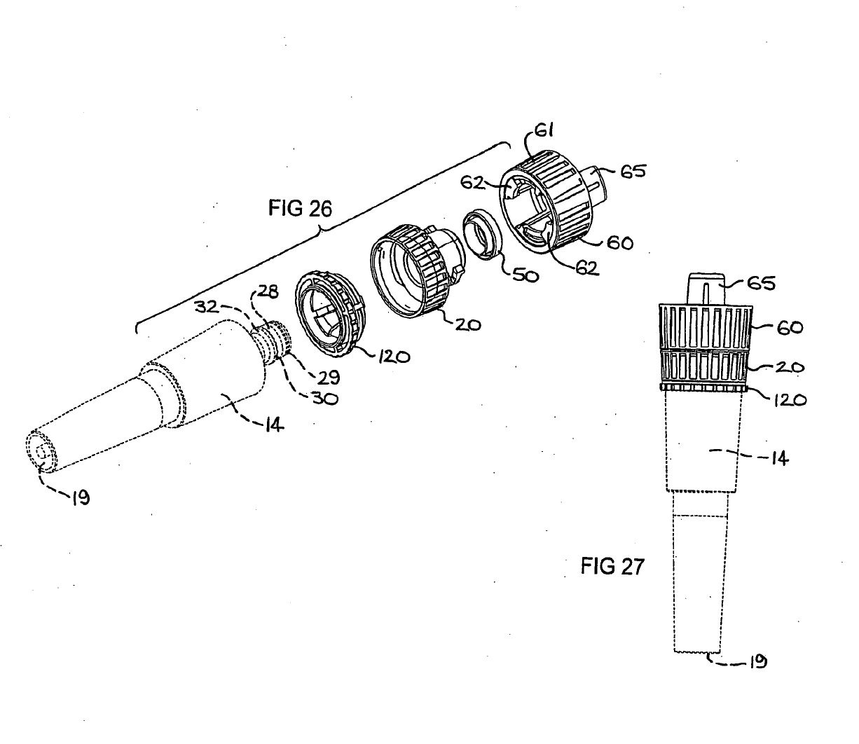

FIG. 26 is an exploded view of an alternative form of adaptor according to the present invention.

FIG. 27 is a side view of the arrangement shown in FIG. 26.

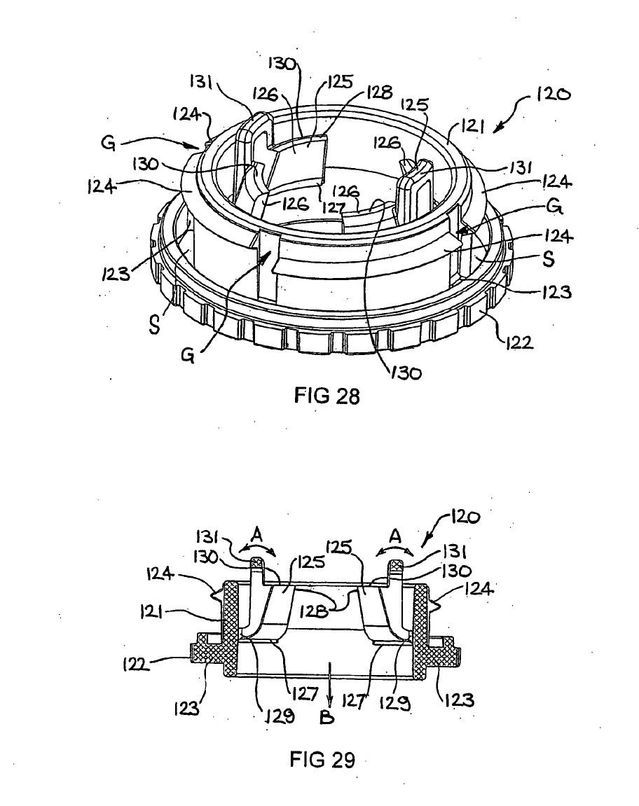

FIGS. 28 and 29 are perspective and cross-sectional views of the adaptor shown in FIG. 26.

The figures to which the following discussion relates, show a complete coupling arrangement for a flexible fluid line. The parts which are discussed can be selected depending on the type of fluid line and it will be appreciated that all of the parts which are discussed are not necessarily required for each application of the coupling arrangement.

It will be convenient to commence discussion of the coupling system by reference to parts of the system as they apply to particular components of a flexible fluid line. Because the invention has been principally developed for use with domestic garden hoses, it will be convenient to describe the invention in relation to that application.

FIG. 1 is a general view of a garden hose arrangement for which the present invention can be employed. FIG. 1 shows a fluid supply facility in the form of a tap 10 which is connected to a flexible fluid line or garden hose 11 by a tap joint 12 according to one aspect of the present invention. The hose 11 is connected to a second hose 13 which extends to a fluid distribution device in the form of a pistol grip nozzle 14 and a nozzle joint 15 is employed to couple the hose 13 to the nozzle 14. A hose joint 16 which has similarities to the joints 12 and 15 is employed to connect the two lengths of hose 11 and 13 together, although where the length of the hose 11 is sufficient, the hose joint 16 will not be necessary. This latter arrangement is illustrated by the hose 11′.

It will be apparent from the discussion that follows, that the respective joints 12, 15 and 16 each comprise two couplings. The joint 15 also includes an adaptor 17. The joints 12 and 15 comprise a coupling 12′ and a coupling 16′. The joint 16 comprises two of the couplings 16′. Accordingly, each joint comprises at least one common coupling 16′. The coupling 12′ of the joint 15 is connected by the adaptor 17 to the nozzle 14. The hoses 11, 11′ and 13 shown in FIG. 1 are of the same diameter. However, it is to be appreciated that the invention can accommodate different diameter hoses within a system such as that shown in FIG. 1. For example, the hose 11 may be of a different diameter to the hose 13. In that case, slight modifications to the couplings 16′ can be made to accommodate the different sized hose ends. Again, this will be apparent from the discussion that follows.

It will be convenient now to disclose the invention in relation to the different joints and couplings shown in FIG. 1 and with reference to FIG. 2 there is illustrated the nozzle 14 in broken outline, with the coupling 12′ and the adaptor 17 of the joint 15 shown in exploded view. FIG. 2a illustrates the FIG. 2 arrangement but with coupling 12′ shown assembled.

The adaptor 17 is connectable to the inlet member 18 of the nozzle 14. The inlet member 18 is cylindrical and includes an inlet passage (not shown), which is coaxial with the member 18 and which facilitates flow of fluid, such as water, into the nozzle 14 for egress through the opposite end 19.

The construction of the adaptor 17 is such that it can be secured to the inlet member 18 in a manner that will be discussed in relation to FIGS. 3 and 4, while the adaptor 17 can also be connected to coupling part 20 by a screw threaded arrangement. Thus the adaptor 17 includes a cylindrical wall 21 which is threaded for engagement with an internal thread of a cylindrical wall 22 of the coupling part 20.

With reference to FIGS. 3 and 4, the adaptor 17 includes a castellated flange 23 which is provided for ease of gripping. As best seen in FIG. 4, the flange 23 extends inboard to the wall 21 at one end of that wall, and towards the other end of the wall 21, and internal thereof, an opening 24 is formed in an end plate 25. The opening 24 is comprised of two intersecting circular portions which are separately defined by part circular edges 26 and 27. The radius of the part circular edge 26 is greater than that of the part circular edge 27 while the axis of the circular edge 27 is concentric with the axis of the wall 21. In contrast, the axis of the circular edge 26 is eccentric to the axis of the wall 21 and the circular edge 27.

The opening 24 is arranged to be sufficiently large, that the inlet member 18 of the nozzle 14 can be fed therethrough. Referring to FIG. 2, the inlet member 18 includes a O-ring groove 28 defined between a pair of flanges 29, 30. The size of the opening 24 of the adaptor 17 therefore is required to be sufficient to accommodate the passage of the flanges 29 and 30 therethrough as well as an O-ring which is disposed within the groove 28. In the adaptor 17, passage of those flanges 29, 30 takes places through the larger portion of the opening 24 defined by the part circular edge 26. However, above the flange 30, i.e. towards the nozzle end 19, the inlet member 18 is of reduced diameter. That section of the inlet member 18 is a neck section 31. The flange 30 therefore defines a cylindrical bearing surface 32 against which the part circular edge 27 can bear against. The edge 27 has a radius complementary to the radius of the outer surface of the neck section 31. Thus, when the inlet member 18 has been fed through the adaptor 17, to the extent that the flanges 29 and 30 have passed through the opening 24, so that the opening 24 is adjacent the neck section 31, the adaptor 17 can be shifted into coaxial alignment with the longitudinal axis of the inlet member 18 so that the part circular edge 27 radially engages against the side wall of the neck section 31 and bears axially against the bearing surface 32. The bearing surface 32 is slightly bevelled, and that bevel is repeated is a complementary form through the part circular edge 27 at 27a, so that the edge 27 and the bearing surface 32 neatly engage against each other.

Movement of the adaptor 17 into position on the inlet member 18, so that the edge 27 bears against the side wall of the neck section 31 and the bearing surface 32, is the first step in securing a coupling according to the invention to the nozzle 14. The next step is to bring the coupling part 20 into threaded engagement with the adaptor 17. A cross-sectional view of the coupling part 20 is shown in FIG. 5 and that view shows the part 20 as having a neck 35 extending from a shoulder 36 which extends to the internally threaded cylindrical wall 22. An opening 37 extends coaxially through the coupling part 20 and comprises three distinct portions. The middle portion 38 has a diameter sufficient to snugly accommodate the end of the inlet member 18 which includes the O-ring groove 28. In practice, an O-ring will be seated within the O-ring groove 28, and that O-ring will engage against the internal wall 39 of the middle portion 38 to seal against water leakage. Thus, water is fed into the coupling part 20 through the leading opening portion 40 and then into the passage defined within the inlet member 18 which is seated within the middle portion 38.

By fitting the adaptor 17 to the inlet member 18, and thereafter by threadably connecting the coupling part 20 to the adaptor 17, the leading end 18a (FIG. 2) of the inlet member 18, is secured within the middle opening portion 38 (FIG. 5) and that securement also secures the adaptor 17 in position with the edge 27 in bearing engagement with both the side wall of the neck section 31 and the bearing surface 32. This is a particularly simple and effective connecting arrangement and facilitates easy connection of a coupling according to the invention to the popular form of nozzle which is illustrated in FIG. 2. The popular part of that nozzle is in fact the shape or configuration of the inlet member 18 and that form of inlet member is applied worldwide to a wide variety of different hose fittings, such as the nozzle 14 illustrated, and other forms of devices, e.g. sprinklers or watering systems. Thus the present invention is operative advantageously to be connected to existing forms of fluid distribution devices. This means that consumers who would like to purchase the coupling system of the present invention, do not also need to purchase new fluid distribution devices which are compatible with the inventive couplings. On the contrary, the inventive couplings can be used with existing fluid distribution devices and that ensures that the coupling of the invention has attractiveness to consumers who already have fluid distribution devices which are in good working order.

The coupling part 20 of FIG. 2 is shown in perspective view in FIG. 6 and in two side views in FIGS. 7 and 8. Those figures show the construction of the neck 35 and the figures show that the neck 35 includes a pair of radially extending projections 41, 42 which are aligned axially on diametrically opposite sides of the neck 35. The axial spacing of the projections 41, 42 defines a groove 43 (FIG. 7) between them. The surface 44 (FIG. 8) of the projection 41 defines a pair of inclined surfaces 45 and 46 and a projecting surface 47. The surfaces 45 to 47 cooperate with a coupling lug which will be described later herein to secure the lug within the groove 43.

The end 48 of the neck 35 is configured for receipt and securement of a flexible seal 50 (FIG. 2). The seal 50 is shown in cross-section in FIG. 9 attached to the end 48 of the coupling part 20. The seal 50 includes an annular lip 51 that projects radially inwardly and which has an inclined face 57. Accordingly, as fluid flows through the neck 35, the fluid impinges on the face 57 and causes the lip 51 to splay outwardly according to the arrows A. The seal 50 further includes a pair of annular flanges 52 and 53. The annular flange 53 is disposed within a recess 54 formed in the end 48 of the neck 35, while the annular flange 52 is seated about the external periphery of the end 48 which defines a neck section 55 having a reduced diameter for complementary receipt of an enlarged end portion 56. Facing engagement of the enlarged end portion 56 with the neck 55 ensures that the seal 50 is securely attached to the end 48.

Referring back to FIG. 2, the coupling part 60 is arranged for connection to the coupling part 20. The coupling part 60 includes a cylindrical side wall 61 and a pair of diametrically opposed lugs 62 which extend radially inwardly from the side wall 61 adjacent one end of the coupling part 60. The lugs 62 are configured to be received between the shoulder 36 (FIG. 7) of the coupling part 20, and the facing projections 42. The lugs 62 are configured to engage opposite sides 63 (FIG. 8) of the projections 42 so that once the projections 42 are in position relative to the lugs 62, they are captured in that position against removal therefrom by engagement with the lugs 62. An internal view of the coupling part 60 is shown in FIG. 10 and that figure shows one of the lugs 62, which has a pair of opposed abutment faces 62a on either side of a supporting surface 64. It is intended that the coupling parts 20 and 60 be rotatably connected together and by that rotation, the projections 42 resiliently deform the ramp part 62b of each lug 62 downwardly to allow the projection 42 to be positioned between the facing abutment surfaces 62a and overlying the supporting surface 64. When recovery of the resilient deformation takes place, the lugs 42 are captured in that position. Accordingly, the coupling parts 20 and 60 are permanently connected together, while the adaptor 17 is removable from connection therewith.

FIG. 11 illustrates the coupling part 60 from the opposite direction to that shown in FIG. 2 and in that figure, a pair of claws 65 are shown extending from an internal surface of the side wall 61. The claws 65 are diametrically opposed and extend axially of the coupling part 60. Each of the claws 65 includes radially inwardly extending projections 66 and those projections have a complementary shape to the shape of the projections 41 shown in FIG. 8. Thus, each projection 66 includes a pair of inclined surfaces 67 and a recess 68. The arrangement of the claws 65 is such that the connected combination of coupling parts 20 and 60 can be sealingly connected to substantially the same combination of parts which is attached to a flexible hose. FIG. 12 illustrates a hose connection, and reference will now be made to that figure.

FIG. 12 illustrates a short portion of hose 70. The hose 70 would extend away from a fluid distribution device, such as a nozzle 14 and through the nut 71.

The FIG. 12 arrangement includes a coupling part 60 which is identical to the part which has the same numeral illustrated in FIG. 2. Additionally, an identical seal 50 is provided and while the coupling part 72 has significant similarities to the coupling part 20, it includes a spigot 73 onto which the hose 70 is mounted. Otherwise, like parts have the same reference numeral plus prime. The spigot 73 has a slight increase in taper from the free end thereof so that the hose 70 frictionally engages the spigot towards it inner end. Disposed around the hose 70, is a hose grip 74 which is radially expandable and contractable by its construction and includes a plurality of teeth 75 that are arranged to bite into the outer surface of the hose 70 when the coupling of the invention is applied to the hose 70. While not all the teeth 75 are visible in FIG. 12, the hose grip 74 is shown in detail in FIG. 13, from which it can be seen that the hose grip 74 includes eight teeth, which are formed in a ring at the end 76 of the grip 74.

The grip 74 is radially expandable and contractable, by virtue of its material of construction, which typically will be a resilient plastic material. The grip 74 is formed into hinged segments of which several are identified by the reference numeral 77 and these segments are connected at hinge regions 78. Again, only a small number of the hinge regions are identified by reference numeral. By the construction of the hose grip 74, the grip can be fitted to hoses of different wall thickness, by radial expansion of contraction of the grip.

Radial contraction of the grip 74 can be caused by engaging either end of the grip 74, at one end by the nut 71 and at the other end by the coupling part 72 (FIG. 12). For this, the coupling part 72 can include an annular ring 81 (see FIG. 12a) which is concentric with and extends about the spigot 73. The ring 81 includes a sloping face 82 complementary to the slope of the end 76′ (FIG. 13) of the grip 74. As shown in the cross-sectional assembled view of FIG. 14, the end 76′ and the sloping face 82 are in engagement and by that engagement, the end 76′ is caused to contract radially inwardly into gripping engagement with the hose 70. Also, the nut 71 engages the end 76 of the grip 74 and causes that end to contract radially inwardly whereby the teeth 75 bite into the hose surface.

Returning to FIG. 12, the assembly of coupling parts is applied to the hose 70, firstly by feeding the hose 70 through the nut 71 and thereafter placing the hose grip 74 about the end of the hose 70. By the resilience of the material of the grip 74, the grip will radially contract into engagement with the outer surface of the hose 70, although the grip force will be very low. After the nut 71 and the hose grip 74 have been applied to the hose 70, the coupling part 72 can be applied to the hose 70 by feeding the spigot 73 into the open end of the hose 70. Typically the spigot 73 will be a friction fit within the hose 70 by engaging the internal walls of the hose. With the spigot 73 fully received within the hose 70, the nut 71 can be threadably engaged with the coupling part 72 through the complementary threads 79 and 80 respectively formed on the nut 71 and the coupling part 72. As the threads 79 and 80 engage, the end 76 of the grip 74 is engaged by the nut 71, while the opposite end 76′ engages the face 82 of the ring 81. The grip 74 is thus caused to radially contract at each end thereof about the hose 70, to grip the hose 70. The teeth 75 of the grip 74 bite into the outer surface of the hose 70. By this arrangement, each of the nut 71, the hose grip 74 and the coupling part 72 are securely fixed to the hose 70.

Following on from the above sequence of connections, if the seal 50 is separate from the coupling part 72, then it is applied to the end 48 of that part in the manner described in relation to FIGS. 6 and 9. It is to be noted that the coupling part 60 is intended to be applied to the coupling part 72 in advance of the sequence of connections discussed above. The actual intention is that the parts 60 and 72 are connected together prior to being made available for consumer purchase, and this might be achieved by connecting them together following their manufacture. Once connected together, it is the further intention that the parts 60 and 72 cannot be separated, except destructively while the seal 50 can be replaced. The assembly of FIG. 12 is illustrated in cross section in FIG. 14, while a side view of that assembly is shown in FIG. 15.

The nozzle coupling assembly shown in FIG. 2a is connectable to the hose coupling assembly of FIG. 15 by engagement of the respective coupling parts 60 of each assembly. As discussed earlier, the coupling parts 60 applied at the nozzle 14 and the hose 70 are identical and it is the case that the projections 66 of the claws 65 of each coupling parts 60, are rotatably engageable within the grooves 43 (FIG. 7), of the coupling parts 20 associated with a respective coupling part 60. The connection requires a simple operation in which the claws 65 of the coupling part 60 associated with the nozzle 14 are introduced into the coupling part 60 associated with the hose 70. With the claws 65 of the respective coupling parts 60 inserted into one another, relative rotation of the coupling parts 60 bring the projections 66 of the claws 65 into the grooves 43 of the respective coupling parts 20. The same type of assembly occurs between the coupling parts 60 and 72 (FIG. 12), or coupling parts 60 and 72′ (FIG. 19). The projections 66 of the respective claws 65 lock within the grooves 43 by receipt of the projecting surface 47 (FIG. 8), within the recess 68 (FIG. 11), and by seating of the respective inclined surfaces 45, 46 and 67.

The joint 16 (FIG. 1) that exists between the hoses 11 and 13 is illustrated in FIGS. 16 and 18, in which FIG. 16 is a cross-sectional view of the joint 16. FIG. 17 is a perspective view of the respective hoses 11 and 13 and their coupling assemblies 91, 92 prior to connection together, while FIG. 18 is a side view of the joint 16. Because many of the parts which will be described in relation to FIGS. 16 to 18 are identical to the parts of FIGS. 2 and 12, the same reference numerals which have been used before to describe those parts will be employed in FIGS. 16 to 18.

The joint 16 is comprised of two identical mating assemblies 91, 92 as follows. Each coupling assembly 91, 92 includes a nut 71 which is in threaded engagement with a coupling part 72. Each assembly further includes a hose grip 74 which, upon threaded connection between the nut 71 and the coupling part 72, bites into the surfaces of the hose 11 and 13 to secure the nut 71 and coupling part 72 in position relative to the hoses 11 and 13. In FIG. 16, the teeth 75 of the hose grip 74 which is applied to the hose 13 are illustrated as penetrating the surface of the hose 13.

The assemblies 91, 92 which make up the joint 16 further include a pair of coupling parts 60 and in relation to the coupling parts 60 and 72 FIG. 16 clearly shows the location of the lugs 62 between the shoulder 36 and the projection 42. FIG. 16 further clearly shows the claws 65 and the projections 66 which extend therefrom disposed between the projections 41 and 42 and in locking engagement with the projection 41.

It will be appreciated that the coupling assembly 91 and the coupling assembly 92 are identical. This is permitted because the hoses 11 and 13 are of the same diameter and thus the spigots 73 are also of the same diameter.

FIG. 19 shows the FIG. 16 arrangement, but with the hose 11′ of different diameter to the hose 13. The main difference in FIG. 19 is in the size of the spigots 73′ and 73. The spigots are of a diameter suitable to be closely received within the respective hoses 11′ and 13. The hose 11′ is of a smaller internal diameter than the hose 13 and so the diameter of the spigot 73′ within the hose 11′ is likewise of a smaller outside diameter compared to the spigot within the hose 13. Also, the nuts 71′ and the hose grips 74′ differ in size between the assemblies 91′ and 92.

FIG. 19 thus illustrates that the invention can connect hoses of different sizes. The internal diameter of the hose 11′ might, for example, be about 12 mm, while the internal diameter of the hose 13′ could be about 18 mm. Clearly hoses of other size can be incorporated.

Advantageously, the arrangements of the invention minimise the number of different parts required to connect hose sections together. Moreover, it will be appreciated that the coupling part 60 which is illustrated in FIGS. 16 to 18, is the same coupling part which is employed for connection to the nozzle 14 (FIG. 1).

Reference will now be made to FIGS. 20 to 22 which show a coupling of the invention being applied to a fluid distribution device in the form of a tap 10 with FIG. 20 showing the tap 10 and coupling assembly in exploded view and FIGS. 21 and 22 showing the assembly in an assembled view, in side view and cross-sectional view respectively.

With reference to FIG. 20, the tap 10 includes a threaded end 101 which is a standard arrangement in relation to domestic outdoor taps.

A seal 102 is provided to engage against an end surface 103 of the tap 10 and against an internal surface of the coupling part 20. The coupling part 20 of FIG. 20 is identical to the coupling part 20 described earlier in FIGS. 2 and 5 to 8, as is the seal 50 and the coupling part 60.

The coupling assembly applied to the tap 10 can be connected to a further coupling assembly connected to a hose, and for example, either of the coupling assemblies 91 and 92 illustrated in FIG. 17 or coupling assemblies 91′ and 92 illustrated in FIG. 19 could be coupled to the assembly connected to the tap 10.

The coupling arrangement hereinbefore described advantageously comprises a number of identical parts. Each of the coupling assemblies described includes the coupling part 60, and either the coupling part 20, 72 or 72′, depending on whether the coupling is to a hose, or to a nozzle or tap. It is to be appreciated that the coupling parts 20, 72 and 72′ differ as indicated previously. Thus there is significant similarity between each of the couplings which are applied to various parts of the domestic hose system illustrated in FIG. 1. Because of this, the system employs more common parts than in the prior art and this provides advantages in relation to manufacturing costs and simplifies the arrangement for consumers who assemble the couplings, while increasing the options for interconnection between different couplings, e.g. for connection between different hose sizes.

A significant advantage of the coupling arrangement according to the invention, is that it can provide a significantly reliable seal between parts which are coupled together. Increasingly, water wastage through leakage losses are being targeted as a significant wastage of water and the elimination of leakage between coupled components is extremely desirable. With reference to FIG. 16, the respective seals 50 of the joint 16 are shown in face to face engagement in the assembled form of the joint 16. This provides for initial sealing between the couplings 91 and 92 but a major feature of the seals 50 is that the radially inwardly extending lip 51 (shown more clearly in FIG. 9) is caused to splay outwardly as shown by the arrows A in FIG. 9 under the action of fluid pressure when fluid flows through the neck 35 of the coupling 20. The same effect occurs to the seal 50 applied to the coupling part 72.

Returning to FIG. 16, with a pair of seals 50 in facing engagement, and with water flowing through the hoses 11 and 13 in either direction, each of the seals 50 are caused to splay in the manner shown in FIG. 9. Thus the lips 51 of the pair of seals splay towards each other and as fluid pressure rises, the force with which the respective lips 51 press against each other increases. Thus advantageously, the integrity of the seal formed between the facing seals 50, increases with fluid pressure. This contrasts with prior art seals between two coupling parts which comprise a pair of facing O-rings. See WO 98/41791 for example. In such prior art arrangements, sealing occurs by forcing the facing O-rings into engagement, but given that fluid pressure tends to force the coupling parts apart, as fluid pressure rises, the sealing pressure between the facing O-rings decreases and thus the seal between the facing O-rings is susceptible to leakage.

Thus, the sealing arrangement of the present invention is considered to be secure against leakage and is not prone to leak when subjected to a combination of hot weather conditions and domestic water pressure. Additionally, the arrangement of the claws 65 is such as to increase the strength of the coupling between respective coupling assemblies 91 and 92, given that the projections 66 of the claws 65 more firmly engage the projections 41 of the coupling parts 20 or 72, as fluid pressure rises.

FIGS. 2 and 20 illustrate the invention as being applied to existing tap and nozzle components. As discussed previously, the ability of the present invention to couple to existing taps and nozzles is advantageous, given that the advantages of the invention, principally the enhanced sealing properties of the invention, can be employed with existing tap and hose componentry, so that a consumer who wishes to take advantage of the enhanced sealing characteristics does not necessarily have to discard the present componentry they have, given that the coupling of the invention is compatible with certain types of existing tap and nozzle componentry. The invention is therefore more likely to be taken up by consumers given that the cost of implementation relates only to the purchase of the couplings themselves.

To couple together a system of the kind disclosed in FIG. 1, the coupling assemblies on each hose end, is identical. Thus the coupling assembly on each hose end comprises a nut 71, a hose grip 74, a coupling part 72, a seal 50 and a coupling part 60. Thus, there are five component parts to be assembled to each end of a hose. Although as indicated above, the coupling parts 60 and 72 would normally already be assembled, so that a consumer would not be required to assemble those parts together. At the nozzle, four components are required, comprising an adaptor 17, a coupling part 20, a seal 50 and a coupling part 60. At the tap end, again four components are required, comprising a seal 102, a coupling part 20, a seal 50 and a coupling part 60. Again, the coupling parts 20 and 60 would already be coupled together.

In a kit form, to connect a single hose between a tap and a nozzle, the kit would include the following components:

Adaptor 17×1

Coupling part 20×2

Seal 50×4

Coupling part 60×4

Coupling part 72×2

Hose grip 74×2

Hose nut 71×2

Seal 102×1

The duplication or commonality of parts is evident from the parts list above.

Where two hoses are employed then the additional connectors of FIGS. 16 or 19 are required, depending on whether the hoses are of the same or different diameter.

While the above discussion has been made principally in relation to existing tap and hose componentry, the present invention is equally applicable to custom made componentry and a nozzle 110 is illustrated in FIGS. 23 to 25. The operation of the liquid dispensing part of the nozzle is of a known kind, such that a shroud 111 is disposed about a central spindle 112 which is integrally formed with a coupling part which is substantially the same as the coupling parts 20 and 72 illustrated earlier. Thus, the coupling part 113 has a neck 114 which is formed identical to the neck 35 of the coupling member 20 and a seal 115 is identical to the seal 50 previously described. Finally, the coupling part 116 is identical to the coupling part 60 previously described.

As shown in FIG. 24, with the parts shown in FIG. 23 coupled together, liquid flows through the coupling part 116 and into the coupling part 113, and thereafter through the spindle 112 and out the shroud 111. Liquid flows through the spindle 112 through openings in each side thereof, while an O-ring 117 is disposed within the groove 118 to prevent leakage of water. The position of the spindle 112 within the shroud 111 controls the fineness of the water spray, and the position of the shroud 111 is adjusted relative to the spindle 112 by rotation on the thread 119.

Clearly other nozzle devices can be employed with the present invention, but FIGS. 23 to 25 illustrate that by manufacturing the back end of such devices according to the construction of the couplings discussed earlier, the nozzle or other devices can be made compatible for coupling with other coupling parts of the present invention.

An alternative form of adaptor is shown in FIGS. 26 and 27. Apart from the adaptor, the components illustrated in FIGS. 26 and 27 are substantially the same as those illustrated in FIG. 2 and therefore the same parts have been given the same reference numerals. However, in FIGS. 26 and 27, an adaptor 120 is illustrated and further discussion in relation to that feature will be made in relation to FIG. 28.

The adaptor 120 includes an annular wall 121 and a castellated flange 122 which is provided for ease of gripping. The flange 122 is connected to the wall 121 by four bridging connectors 123 which are disposed equidistantly about the flange 122 at 90° intervals. The bridging connectors 123 separate the annular flange 122 from the wall 121 to create an annular space S, small sections of which are evident in FIG. 27. The annular space S forms an opening for the core of a mould which forms thread portions 124.

The wall 121 includes four thread portions 124. The thread portions 124 are separated by gaps G, which provide space for the core of a mould to form the bridging connectors 123, although despite the gaps G, the thread portions 124 form a substantially continuous, single revolution helical thread.

Radially inwardly of the wall 121, are a pair of diametrically opposed and substantially identical snap portions 125. Each snap portion 125 includes engagement portions 126 which taper radially inwardly from the leading end 127 to the trailing end 128.

The snap portions 125 are connected to the internal surface of the wall 121 at hinges 129 (see FIG. 28), and the hinges 129 are resiliently flexible to allow the snap portions 125 to flex inwardly and outwardly as shown by the arrows A in FIG. 28. Flexing movement of this kind is required for the snap portions 125 to engage the inlet member 18 of the nozzle 14. The arrangement is such that the snap portions 125 flex radially outwardly towards the wall 121, in order to ride over the flanges 29 and 30 of the inlet member 18 and to rest in bearing engagement with the bearing surface 32 of the flange 30. Movement onto the inlet member 18 is in the direction of the arrow B of FIG. 28. Once the snap portions 25 have ridden over the flanges 29 and 30, the end surfaces 130 of the engagement portions 126 snap into bearing engagement with the bearing surface 32.

Upon application of the adaptor 120 to the inlet member 18, the coupling part 20 can be threadably connected to the adaptor 120 by threadably engaging the helical thread portions 124. Thereafter, the seal 50 and the coupling part 60 can be connected as described earlier.

Advantageously, the adaptor 120 can be removed from the inlet member 18 by manually gripping the levers 131 to resiliently flex the snap portions 125 to release them from engagement with the bearing surface 32. Thereafter, the adaptor 120 can be shifted axially off the inlet member 18.

The adaptor 120 is easy to manufacture and it contrasts with the adaptor 17, by the snap-on nature of its connection with the inlet member 18. It is considered that this aspect of the adaptor 120 might make it more attractive than the nut 17, although the nut 17 is considered to provide more secure connection. Accordingly, both forms of nut have advantages.

It is to be noted that the arrangements of FIGS. 2 and 25, utilizing the separate adaptor 17 and 120, each require that the coupling part 20 be removed from connection with respective adaptor 17, 120, before the respective adaptor can be removed from the inlet member 18. In FIG. 2, when the coupling part 20 is threadably connected to the adaptor 17, the adaptor 17 cannot shift out of coaxial alignment with the inlet member 18 and therefore the edge 27 (FIG. 3), cannot be disengaged from the bearing surface 32.

Likewise, with the coupling part 20 threadably connected to the adaptor 120, the levers 131 are concealed by the wall 22, so that access to those levers is not available. Accordingly, only after the coupling part 20 is unthreaded from the adaptor 120, can the levers 131 be accessed for removal of the adaptor 120. It is to be noted however, that the adaptor 120 will remain fixed to the inlet member 18 because of the snap fit engagement between those two parts, even though the coupling part 20 is removed from connection with the adaptor 120. In contrast, the adaptor 17 is not positively located on the inlet member 18 unless the coupling part 20 is threadably connected to the adaptor 17.

It should be noted that while the description of drawings has concentrated on a system of the kind shown in FIG. 1, the interconnectability of the first and second couplings is such that the following combination of connections can be made:
first coupling to second coupling;
first coupling to first coupling; and
second coupling to second coupling.

Thus, with reference to FIG. 1, the couplings 12′ can be connected together, as can the couplings 16′, as well as the coupling 12′ and 16′. All of these combinations are within the scope of the present invention.

The invention described herein is susceptible to variations, modifications and/or additions other than those specifically described and it is to be understood that the invention includes all such variations, modifications and/or additions which fall within the spirit and scope of the above description.

1. A coupling arrangement for coupling a flexible fluid line between a fluid supply facility and a fluid discharge facility, the coupling arrangement includes a first coupling which is connectable to the fluid supply facility and to the fluid discharge facility, and a second coupling which is connectable to opposite ends of the flexible fluid line, the first and the second couplings are connectable together to form a joint, each of the first and second couplings defines a passage through which fluid can flow, and in a connected condition of the first and second couplings, the respective passages are in alignment to allow flow of fluid through the joint, each of the first and second couplings includes first and second interconnecting coupling parts, in which the first coupling part defines the passage of the coupling, the first coupling part of the first coupling is connectable to one of the fluid supply or fluid discharge facilities, the second coupling part of each coupling is connectable to the first coupling part of the coupling with which it is associated, and to the first coupling part of the other coupling of the joint, the first and second couplings are coupled together by releasable connection between the second coupling part of each coupling with the first coupling part of the mating coupling.

2. A coupling arrangement according to claim 1, including an adaptor to connect the first coupling part of the first coupling to the fluid discharge facility.

3. A coupling arrangement according to claim 2, wherein the adaptor includes first and second portions, the first portion being arranged to be secured to a male connector of the fluid discharge facility and the second portion being arranged to be connected to the first coupling part of the first coupling.

4. A coupling arrangement according to claim 3, wherein the first portion includes an opening through which the male connector can be fed and an edge of the opening is arranged to bear against a bearing surface of a flange of the male connector, the bearing engagement resisting removal of the male connector from the opening and thus resisting removal of the adaptor from the male connector.

5. A coupling arrangement according to claim 4, wherein the opening includes two intersecting portions, a first portion being sized to accept the male connector when the connector is fed into the opening and a second portion being sized and shaped for engagement with the bearing surface of the connector flange.

6. A coupling arrangement according to claim 5, wherein each of the first and second portions is circular with the first portion having a diameter that is slightly greater than the maximum diameter of the portion of the male connector that is fed through the opening, and the second portion having a reduced diameter and shaped complementary to the outer surface of the male connector from which the flange extends, so that an edge of the second portion can bear radially against the outer surface of the male connector and axially against the bearing surface of the flange.

7. A coupling arrangement according to claim 3, wherein the male connector includes a flange which defines a bearing surface and the adaptor includes first and second portions, the first portion includes one or more snap connectors which are arranged to ride over the flange and bear against the bearing surface.

8. A coupling arrangement according to claim 7, wherein the second portion includes an annular wall, the or each snap connector being connected to an internal surface of the wall and a thread is applied to an external surface of the wall for connecting the second portion to the first coupling part.

9. A coupling arrangement according to claim 1, wherein the first coupling part of the second coupling includes a spigot for receipt within an end of a fluid line, the spigot being tubular and in fluid communication with the passage of the first coupling part.

10. A coupling arrangement according to claim 1, including a seal mounted at one end of the passage of a first coupling part, wherein in a connected condition of the first and second couplings, the seal seals between the passages of the first coupling parts of the first and second couplings.

11. A coupling arrangement according to claim 1, including a seal mounted at the end of the passage of each first coupling part, wherein in a connected condition of the first and second couplings, the seals are in facing relationship and have a construction to sealingly engage each other to substantially prevent flow of fluid within the joint other than from one passage of the joint to the other.

12. A coupling arrangement according to claim 1, wherein the passage of each first coupling part extends through an interlocking portion of the first coupling part, the interlocking portion being arranged to interlock with each second coupling part of the first and second couplings, firstly to connect first and second coupling parts together to form the first and second couplings and secondly to connect the first and second couplings together to form a joint.

13. A coupling arrangement according to claim 12, wherein the first coupling part includes a connecting section for connection to one of a fluid supply facility, a fluid discharge facility or a fluid line, the interlocking portion extending from the connecting section, and a shoulder being defined at the junction between the interlocking portion and the connection section, the shoulder extending transverse to the axis of the passage of the first coupling part and forming an abutment surface for abutment with the second coupling part.

14. A coupling arrangement according to claim 13, wherein the interlocking portion includes one or more locking projections spaced from the shoulder and the second coupling part includes one or more locking lugs that are received between the shoulder and the locking projections when the first and second coupling parts are connected together, the locking lugs include abutments suitable to capture the locking projections and to secure the first and second coupling parts together.

15. A coupling arrangement according to claim 14, wherein the locking projections are captured by relative rotation between the first and second coupling parts.

16. A coupling arrangement according to claim 14, wherein each second coupling part includes a locking claw comprising an axially extending section which extends generally parallel to the axis of the passage of the first coupling part, and a radially extending section that extends radially inwardly from the axially extending section, the radially extending section engaging with a locking projection of the first coupling part interlocking portion, to connect the second coupling part of one of the first and second couplings to the first coupling of the other of the first and second couplings.

17. A coupling arrangement according to claim 16, wherein the second coupling part includes two locking claws, diametrically spaced apart.

18. A coupling arrangement according to claim 1, further including a grip for gripping an end of a flexible fluid line, the grip including a plurality of elongate segments which are positioned generally parallel to and adjacent to each other and each segment is hingedly connected at one end thereof to one adjacent segment on one side thereof and at the other end thereof to an adjacent segment on an opposite side thereof, the hinge connections between adjacent segments permitting the segments to shift relative to each other, a clamping nut being provided to engage the grip and to cause it to radially contract and grip the outside surface of the fluid line, the nut being securable to the first coupling part of the second coupling.

19. (canceled)

20. (canceled)

21. A coupling arrangement for coupling a flexible fluid line between a fluid supply facility or a fluid discharge facility, the coupling arrangement includes a first coupling which is connectable to the fluid supply facility or to the fluid discharge facility, and a second coupling which is connectable to an opposite end of the flexible fluid line, the first and the second couplings are connectable together to form a joint, each of the first and second couplings defines a passage through which fluid can flow, and in a connected condition of the first and second couplings, the respective passages are in alignment to allow flow of fluid through the joint, each of the first and second couplings includes first and second interconnecting coupling parts, in which the first coupling part defines the passage of the coupling, the first coupling part of the first coupling is connectable to one of the fluid supply or fluid discharge facilities, the second coupling part of each coupling is connectable to the first coupling part of the coupling with which it is associated, and to the first coupling part of the other coupling of the joint, the first and second couplings are coupled together by releasable connection between the second coupling part of each coupling with the first coupling part of the mating coupling.
